(19) United States
(12) Patent Application Publication
(10) Pub. No.: US 2026/0190056 A1
(43) Pub. Date: Jul. 2, 2026

(54) TWO-WAY TIME TRANSFER AND RANGING THAT MEASURES AND COMPENSATES FOR DOPPLER SHIFTS

(71) Applicant: THE AEROSPACE CORPORATION, El Segundo, CA (US)

(72) Inventor: Alexander C. Utter, Hawthorne, CA (US)

(73) Assignee: THE AEROSPACE CORPORATION, El Segundo, CA (US)

(21) Appl. No.: 19/008,053

(22) Filed: Jan. 2, 2025

(51) Int. Cl. H04W 56/00; H04W 64/00

(52) U.S. Cl. CPC H04W 56/004; H04W 56/0035; H04W 64/006

(57) ABSTRACT

Two-way time transfer and ranging that measures and compensates for Doppler shifts is provided herein. A first endpoint transmits a request message initializing a dopplerField (DF). Relay node(s) moving relative to the first endpoint receive the request message, measure ingress and egress frequency ratios, increment DF by a difference between these ratios, and transmit the request message containing the incremented DF. A second endpoint receives the request message containing the incremented DF, and generates a reply message containing the incremented DF. The relay node(s) receive the reply message, measure ingress and egress frequency ratios, increment the incremented DF by a difference between these ratios, and transmit the reply message containing the incremented DF. The first endpoint receives the reply message containing the incremented DF, and uses it to calculate a range-rate of components in the mobile network relative to the first endpoint.

### STATEMENT OF GOVERNMENT INTEREST

This invention was made with government support under Contract No. FA8802-19-C-0001 awarded by the Department of the Air Force. The government has certain rights in the invention.

### FIELD

This application generally relates to two-way time transfer and ranging.

### BACKGROUND

Two-way time transfer and ranging (TWTTR) includes simultaneous clock synchronization and ranging between two or more transceivers. A collection of transceivers, separated by possibly a large distance (for example, even on opposite sides of the earth), are to have their relative ranges determined and simultaneously have their clocks synchronized via signals sent strictly between the transceivers with no outside help. For example, if the clocks synchronized to a common global positioning system (GPS) signal, they could synchronize, but it would not fall under the nomenclature of “two-way time transfer”. It would be useful to have the capacity for range determination and clock synchronization even when GPS signals or supporting ground processing are not available. The term “time transfer” may be thought of as “transferring” the time of one clock to the other via signals sent among them, but more generally relates to clock synchronization.

Systems may need to achieve clock synchronization or range determination for a variety of reasons. The most well-known example is the GPS space segment, i.e., the satellites that transmit the GPS signal. For example, to enable a receiver on earth to determine its location and synchronize its clock with GPS time, the GPS satellites need to have their clocks highly synchronized and their varying ephemerides accurately determined. GPS satellites achieve zero-day clock synchronization to the order of 0.1 to 1 nanoseconds and zero-day weighted ephemeride estimates to an accuracy of 10 to 20 centimeters. Another example is a very large array of radio telescopes exploring the universe, for which accurate direction finding may benefit from sufficiently accurate array element ranging and clock synchronization.

### SUMMARY

Examples herein provide two-way time transfer and ranging that measures and compensates for Doppler shifts.

Some examples provide a method for calculating a range-rate in a mobile network. The method may include transmitting, by a first endpoint in a mobile network, a request message initializing a dopplerField (DF). The method may include receiving, by one or more relay node(s), at least some of which may be moving relative to the first endpoint, the request message. The method may include measuring, by each relay node, an ingress frequency ratio of the request message and an egress frequency ratio of the request message. The method may include incrementing, by each relay node, DF by a difference between the ingress frequency ratio and the egress frequency ratio of the request message. The method may include transmitting, by each relay node, the request message containing the incremented DF. The method may include receiving, by a second endpoint, the request message containing the incremented DF. The method may include generating, by the second endpoint, a reply message containing the incremented DF. The method may include receiving, by each relay node, the reply message. The method may include measuring, by each relay node, an ingress frequency ratio of the reply message and an egress frequency ratio of the reply message. The method may include incrementing, by each relay node, the incremented DF by a difference between the ingress frequency ratio and the egress frequency ratio of the reply message. The method may include transmitting, by each relay node, the reply message containing the incremented DF. The method may include receiving, by the first endpoint, the reply message containing the incremented DF. The method may include using, by the first endpoint, the incremented DF to calculate a range-rate of components in the mobile network relative to the first endpoint.

In some examples, the request message transmitted by the first endpoint further contains a correctionField (CF). In some examples, the method further includes incrementing, by each relay node, CF in the request message using operations that include measuring, by each relay node, an ingress timestamp of the request message and an egress timestamp of the request message; estimating, by each relay node, a first next-hop range rate; and incrementing, by each relay node, CF using the first next-hop range rate and a difference between the ingress timestamp and the egress timestamp of the request message. In some examples, the reply message comprises the incremented CF, and the method further includes incrementing, by each relay node, the incremented CF in the reply message using operations that include measuring, by each relay node, an ingress timestamp of the reply message and an egress timestamp of the reply message; estimating, by each relay node, a second next-hop range rate; and incrementing, by each relay node, the incremented CF using the second next-hop range rate and a difference between the ingress timestamp and the egress timestamp of the reply message.

In some examples, the DF comprises a Type, Length, Value (TLV) field of a Precision Time Protocol (PTP).

Some examples herein provide a method for calculating a range-rate in a mobile network. The method may include transmitting, by an endpoint in a mobile network to a node in the mobile network, a request message initializing a dopplerField (DF). The method may include receiving, by the endpoint from the node, a reply message containing the DF which has been incremented by at least the node. The method may include using, by the endpoint, the incremented DF to calculate a range-rate of components in the mobile network relative to the endpoint.

In some examples, the request message transmitted by the first endpoint further contains a correctionField (CF).

In some examples, the DF comprises a Type, Length, Value (TLV) field of a Precision Time Protocol (PTP).

In some examples, the DF was incremented a first time by the node when receiving the request message from the endpoint, and incremented a second time by the node when transmitting the reply message to the endpoint.

Some examples herein provide a method for responding to a request message in a mobile network. The method may include receiving, by an endpoint in a mobile network, a request message containing an incremented dopplerField (DF). The method may include transmitting, by the endpoint, a reply message containing an echo of the incremented DF.

Some examples herein provide a mobile network. The mobile network may include a first endpoint configured to transmit a request message initializing a dopplerField (DF). The mobile network may include one or more relay node(s), at least some of which may be moving relative to the first endpoint. The one or more relay node(s) may be configured to receive the request message. The one or more relay node(s) may be configured to measure an ingress frequency ratio of the request message and an egress frequency ratio of the request message. The one or more relay node(s) may be configured to increment DF by a difference between the ingress frequency ratio and the egress frequency ratio of the request message. The one or more relay node(s) may be configured to transmit the request message containing the incremented DF. The mobile network may include a second endpoint configured to receive the request message containing the incremented DF and to generate a reply message containing the incremented DF. The one or more relay nodes further may be configured to receive the reply message. The one or more relay nodes further may be configured to measure an ingress frequency ratio of the reply message and an egress frequency ratio of the reply message. The one or more relay nodes further may be configured to increment the incremented DF by a difference between the ingress frequency ratio and the egress frequency ratio of the reply message. The one or more relay nodes further may be configured to transmit the reply message containing the incremented DF. The first endpoint further may be configured to receive the reply message containing the incremented DF. The first endpoint further may be configured to use the incremented DF to calculate a range-rate of components in the mobile network relative to the first endpoint.

In some examples, the request message transmitted by the first endpoint further contains a correctionField (CF). In some examples, each relay node is configured to increment CF in the request message using operations that include measuring an ingress timestamp of the request message and an egress timestamp of the request message; estimating a first next-hop range rate; and incrementing CF using the first next-hop range rate and a difference between the ingress timestamp and the egress timestamp of the request message. In some examples, the reply message includes the incremented CF, and each relay node further may be configured to increment the incremented CF in the reply message using operations that include measuring an ingress timestamp of the reply message and an egress timestamp of the reply message; estimating a second next-hop range rate; and incrementing the incremented CF using the second next-hop range rate and a difference between the ingress timestamp and the egress timestamp of the reply message.

In some examples, the DF comprises a Type, Length, Value (TLV) field of a Precision Time Protocol (PTP).

Some examples herein provide an endpoint for use in a mobile network. The endpoint may be configured to perform operations that include transmitting, to a node in the mobile network, a request message initializing a dopplerField (DF). The operations may include receiving, from the node, a reply message containing the DF which has been incremented by at least the node. The operations may include using the incremented DF to calculate a range-rate of components in the mobile network relative to the endpoint.

In some examples, the request message transmitted by the first endpoint further contains a correctionField (CF).

In some examples, the DF comprises a Type, Length, Value (TLV) field of a Precision Time Protocol (PTP).

In some examples, the DF was incremented a first time by the node when receiving the request message from the endpoint, and incremented a second time by the node when transmitting the reply message to the endpoint.

Some examples herein provide an endpoint for use in a mobile network. The endpoint may be configured to perform operations that include receiving a request message containing an incremented dopplerField (DF); and transmitting a reply message containing an echo of the incremented DF.

### BRIEF DESCRIPTION OF DRAWINGS

FIG. 1 illustrates conventional two-way time transfer and ranging (TWTTR) messaging between stationary transceivers.

FIG. 2 schematically illustrates an example multi-hop computer network.

FIG. 3 illustrates conventional IEEE-1588 Precision Time Protocol (PTP) messaging for TWTTR in a multi-hop computer network.

FIG. 4 illustrates an example manner in which relative motion of a relay node affects PTP messaging in a multi-hop computer network.

FIG. 5 illustrates an example manner in which relative motion of some or all nodes affects PTP messaging in a multi-hop computer network.

FIG. 6A illustrates an example flow of operations in a method implemented by a relay node (e.g., transparent clock) for TWTTR using Doppler shifts, according to some examples provided herein.

FIG. 6B illustrates an example flow of operations in a method implemented by a first endpoint (e.g., client) for TWTTR using Doppler shifts, according to some examples provided herein.

FIG. 6C illustrates an example flow of operations in a method implemented by a second endpoint (e.g., server) for TWTTR using Doppler shifts, according to some examples provided herein.

FIG. 7 schematically illustrates an example system implementing Doppler-PTP, according to some examples provided herein.

### DETAILED DESCRIPTION

Examples herein provide two-way time transfer and ranging that measures and compensates for Doppler shifts. For example, the IEEE-1588 Precision Time Protocol (PTP) performs two-way time transfer and ranging (TWTTR) over complex multi-hop computer networks. However, deep-rooted assumptions prevent the use of conventional PTP in multi-hop computer networks in which clocks are in motion, e.g., in mobile networks. Provided herein are systems and methods for measuring total range-rate using Doppler shifts for TWTTR in multi-hop computer networks, for example by generating Doppler-aware extensions to PTP.

### 1. Introduction

Many applications require precise time distribution to devices distributed over a wide area. Examples such as distributed radio beamforming or long-baseline radio-astronomy generally require all transceivers to be phase-synchronous, i.e., time-synchronized to within a fractional period of the radio-frequency carrier. Other examples, such as time-difference of arrival (TDOA) measurements for direction-finding, have a direct relationship between the timing error and the angular or positional resolution. Global navigation satellite services (GNSS) are a ubiquitous solution to this problem, because they offer a unique combination of low cost, high accuracy, and near-ubiquitous availability. However, some applications require accuracy or resilience requirements that cannot be met by GNSS.

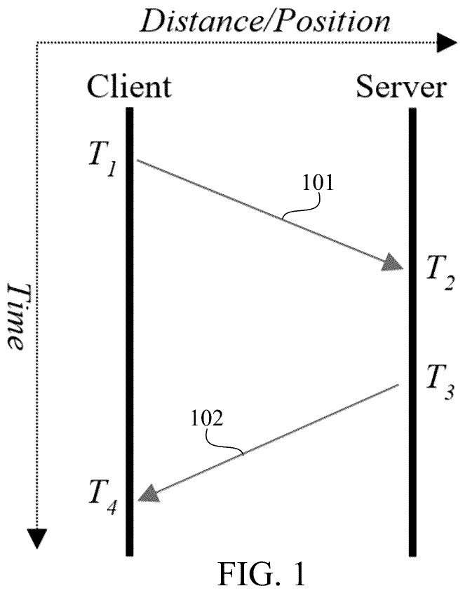

One solution is two-way time transfer and ranging (TWTTR) over a wired or wireless communication link. By exchanging signals between two TWTTR endpoints, each can measure the propagation delay (i.e., range or pseudorange) and the time-offset between the local and remote clocks. The classical TWTTR handshake is shown in FIG. 1, in which a first endpoint sends a “request” message to a second endpoint, and the second endpoint sends a “reply” message to the first endpoint. Illustratively, the first endpoint may be a client seeking to determine its time-offset from a reference time issued by the second endpoint, and the second endpoint may be a server which provides the reference time desired by the client. Each endpoint measures the transmit and receive times of the “request” and “reply” messages using that endpoint's local clock. In a manner such as described further below, under certain conditions, these four timestamps may be sufficient for the endpoints to solve the time and range parameters of interest, while under other conditions, these four timestamps are insufficient to solve for the time and range parameters of interest.

Broadly, a goal of any TWTTR protocol may be described as measuring the offset between two distant clocks (i.e., time-transfer) and measuring the path-delay for messages traversing a given path (i.e., ranging). In PTP, these quantities respectively are referred to as offsetFromMaster and meanPathDelay. Related quantities such as transit time, channel-delay, pseudorange, path-length, round-trip delay, and the like, are equivalent to or derivable from the path-delay.

### 2. Constant Path-Delay

This section provides certain background information explaining certain assumptions behind the conventional TWTTR process.

Conventional TWTTR assumes that path-delay is both constant and symmetric for any given communication link. Constant delay means that two messages sent at different times will have the same path-delay from sender to receiver. Symmetric delay means that the path-delay for a given request message is equal to the path-delay of a message replying to that request. That is, when the delay is symmetric, then switching the sender and recipient along a given path yields the same path-delay.

The assumptions of constant and symmetric path-delay are typically valid in static cases, where all network nodes are stationary and each segment has a fixed (but unknown) channel-delay or path-delay. In static cases, the path-delay is proportional to the path-length because delay is defined by the propagation speed of a message or signal through the associated fixed-length network cable or point-to-point wireless link. For most electrical or optical signals, the signal propagation speed is equal to the speed of light in that medium.

Under such assumptions, a single back-and-forth message exchange, such as shown in FIG. 1, is sufficient to derive both time-transfer and ranging parameters. FIG. 1 illustrates conventional TWTTR messaging between stationary transceivers. In FIG. 1, the vertical axis indicates time measured by an omniscient observer. The horizontal axis indicates abstract position, equivalent to distance between a first endpoint (e.g., client that generates a request message) and a second endpoint (e.g., server that generates a reply message responsive to the request message). In this model, a single position axis is sufficient to represent the request message's progress along the path from the first endpoint to the second endpoint, and the reply message's progress along the path from the second endpoint to the first endpoint. The physical path need not necessarily be a straight line, but the axis indicates distance travelled by the message along that path. The signal propagation speed sets the slope of line 101 illustrating the propagation of the “request” message, which the first endpoint (e.g., client) sends at time T₁ and the second endpoint (e.g., server) receives at time T₂, and also sets the slope of line 102 illustrating the propagation of the “reply” message, which the second endpoint sends at time T₃ and the first endpoint receives at time T₄.

Under the conditions in which the propagation delay of the request and reply messages is constant and symmetric, from the messages' respective transmit and receive timestamps (i.e., T₁ and T₂ for the request message and T₃ and T₄ for the reply message) the first endpoint calculates offsetFromMaster and meanPathDelay as follows:

$$meanPathDelay = \frac{( {T}_{4} - {T}_{3} ) + ( {T}_{2} - {T}_{1} )}{2} \qquad ( 1 )$$

$$offsetFromMaster = {T}_{2} - {T}_{1} - meanPathDelay \qquad ( 2 )$$

### 3. Queuing Delays

The IEEE-1588 Precision Time Protocol (PTP) is a protocol for performing TWTTR over a multi-hop computer network. PTP's current implementation is described in “IEEE Standard for a Precision Clock Synchronization Protocol for Networked Measurement and Control Systems.” IEEE Std 1588-2019, the entire contents of which are incorporated by reference herein.

This section describes how conventional PTP mitigates unpredictable queueing delays associated with multi-hop computer networks. Most computer networking equipment adds packet-queueing, and other digital elements, that cause incidental messaging delays that are unrelated to the signal-propagation delays discussed in the previous section. For example, queueing delays are necessary for the equipment to function, but they may be unpredictable, highly variable, and unrelated to the parameters of interest for TWTTR. If incidental delays were to be uncompensated, the unpredictability of such delays would severely compromise the precision and accuracy of the TWTTR process.

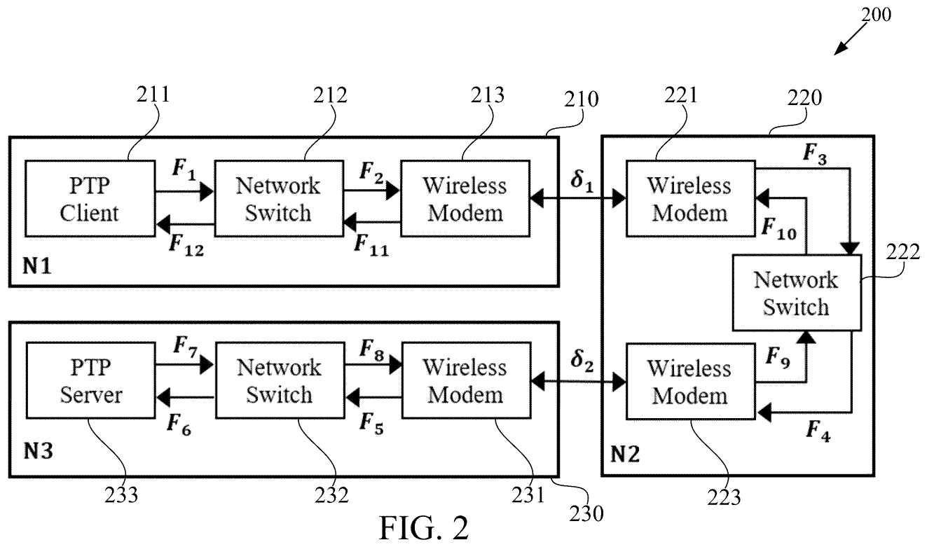

For example, FIG. 2 schematically illustrates an example multi-hop computer network 200. This example network 200 includes three nodes N1, N2, and N3 (210, 220, 230). Each node contains a network switch or router (212, 222, 232) for local communications, and one or more wireless modem(s) for point-to-point communications with other nodes (213, 221, 223, 231). In this example, first node 210 contains a first endpoint (e.g., PTP client 211), second node 220 comprises a relay for messages between the first node 210 and third node 230, and third node 230 contains a second endpoint (e.g., PTP server 233 acting as a master clock). In a multi-hop PTP path, each endpoint (e.g., 211, 233) may be referred to as an “ordinary clock” or “boundary clock,” and any intermediate network device (e.g., 212, 222, 232) may be referred to as a “transparent clock.”

The term “client” herein may be used herein to indicate an endpoint that initiates a TWTTR exchange by sending the first message of that exchange. For example, a master clock may initiate a TWTTR exchange by generating a SYNC message to which a slave clock may reply with DELAY_REQ message. Here, the master clock may correspond to the client 211, the SYNC message may correspond to the request message, the slave clock may correspond to the server 233, and the DELAY_REQ message may correspond to the reply message. Or, for example, a slave clock may initiate a TWTTR exchange by generating a DELAY_REQ message to which the master clock may reply with a SYNC message. Here, the slave clock may correspond to the client 211, the DELAY_REQ message may correspond to the request message, the master clock may correspond to the server 233, and the SYNC message may correspond to the reply message.

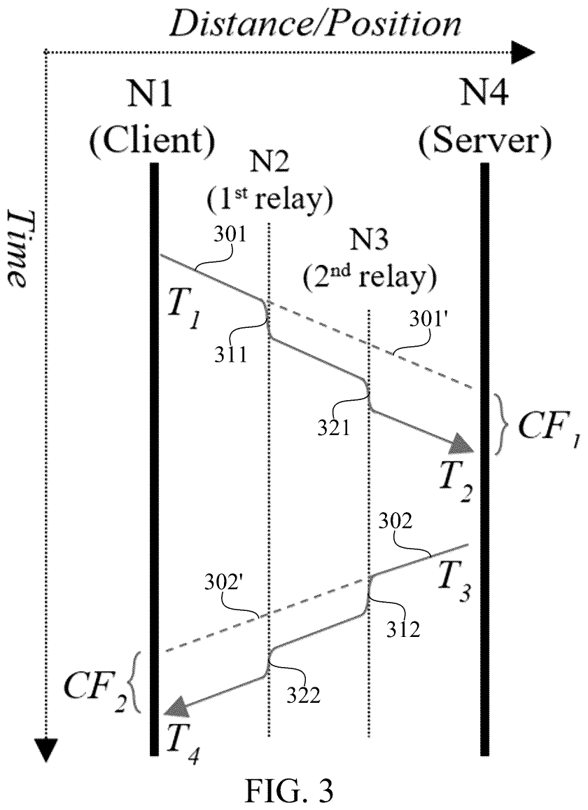

The PTP specification defines the “transparent clock” role for PTP-compatible equipment as messages traverse the multi-hop computer network. Typically, network switches and routers act as transparent clocks. While only a single relay node N2 is illustrated in FIG. 2 for simplicity, it may be appreciated that multi-hop computer networks may include a plurality of relay nodes (each containing one or more transparent clocks) between the first and second endpoints, e.g., in a manner such as will be described with reference to FIGS. 3-5. In the example shown in FIG. 2, incidental delays potentially may occur within or between each of nodes N1, N2, and/or N3. For example, the network switch within each of the nodes may cause a queuing delay.

To mitigate queuing delays and other such incidental delays, the PTP specification adds an additional parameter to each TWTTR message: the correctionField (CF). Specifically, a first ordinary clock (e.g., PTP client 211 of node N1) may generate a TWTTR request message to be sent to a second ordinary clock (e.g., PTP server 233 of node N3). In accordance with PTP, the first ordinary clock initializes a CF in the request message. As transparent clocks in the multi-hop computer network transmit the request message to the second ordinary clock (e.g., PTP server 233 of N3), those transparent clocks increment the value of CF. The term “increment” herein refers to any operation of receiving a message containing a numeric field, decoding the value of the numeric field, modifying the value according to a prescribed process, encoding the modified value to replace the numeric field, and transmitting a message containing the modified numeric field. In some embodiments, the prescribed process may be simple addition or subtraction. For example, the PTP correctionField is incremented by receiving a PTP message, decoding the correctionField, adding elapsed time (i.e., the difference between egress and ingress timestamps according to the PTP specification), replacing the correctionField, and transmitting the modified PTP message.

On receiving the TWTTR request message, the second ordinary clock records the received CF (i.e., CF₁ associated with the as-received request message) and then generates a TWTTR reply message to be sent to the first ordinary clock. The TWTTR reply message initializes the outgoing CF according to the methods prescribed in the PTP specification. The transparent clocks in the network then respectively increment the value of the reply message's CF as those transparent clocks transmit the reply message to the first ordinary clock. The first ordinary clock (PTP client at N1) records the received CF (i.e., CF₂ associated with the as-received reply message), and uses quantities CF₁ and CF₂ to calculate offsetFromMaster and meanPathDelay in a manner such as described below with reference to equations (3) and (4), as set forth in the PTP specification.

FIG. 3 illustrates conventional PTP messaging for TWTTR in a multi-hop computer network. The example shown in FIG. 3 includes three hops, i.e., a client at a first node N1, a first transparent clock at a second node N2, a third transparent clock at a third node N3, and a server at a fourth node N4. The client (at N1) initiates the TWTTR exchange by generating the first message (request message) at time T₁. After N1 transmits the first message, the first message moves towards the first transparent clock at N2 along a wired or wireless communications medium, propagating at a speed associated with that medium. When the first message reaches N2, the message is queued within the digital circuitry of that relay node. Until N2 transmits the message onto the next network segment (i.e., the medium leading to the next node N3), the first message makes no physical progress towards the next destination. In FIG. 3, the queuing delay caused by N2 is indicated by vertical segment 311 in the position-vs-time curve 301 for the first message. Similarly, when the first message reaches the second transparent clock at N3, the message is queued within the digital circuitry of that relay node, and until N3 transmits the message onto the next network segment, the first message makes no physical progress towards the next destination, here the PTP server (at N4). In FIG. 3, the queuing delay caused by N3 is indicated by vertical segment 321 in the position-vs-time curve 301 for the first message. The dotted line 301′ indicates the first message's hypothetical position-vs-time if it had continued propagating toward node N4 at the normal speed of that message's propagation through the transmission medi(a), unhindered by the incidental delays that nodes N2 and N3 introduce.

The second message (reply message) originates at the server (N4) at time T₃. After N4 transmits the second message, the second message moves towards N3, where the second message is queued until N3 transmits the message onto N2. In FIG. 3, the queuing delay caused by N3 is indicated by vertical segment 312 in the position-vs-time curve 302 for the second message. Similarly, when the second message reaches N2, the message is queued until N2 transmits the message onto the next node, here N1. In FIG. 3, the queuing delay caused by N2 is indicated by vertical segment 322 in the position-vs-time curve 302 for the second message. The dotted line 302′ indicates the second message's hypothetical position-vs-time if it had continued propagating toward node N1 at the normal speed of that message's propagation through the transmission medi(a), unhindered by the incidental delays that nodes N3 and N2 introduce.

As noted above, in PTP each transparent clock (relay node) along the multi-hop path increments CF in the message it transmits, to indicate that relay node's added delay. As a result, each PTP message includes the total CF for all relay nodes along the path of that message. In the example shown in FIG. 3, the CF for the request message that N4 receives from N1 via N2 and N3 is denoted CF₁, and the CF for the reply message that N1 receives from N4 via N3 and N2 is denoted CF₂. The value of CF₁ is equal to the distance along the vertical axis in FIG. 3 between curve 301 and line 301′, and the value of CF₂ is equal to the distance along the vertical axis in FIG. 3 between curve 302 and line 302′.

In accordance with the PTP specification, the PTP client (first ordinary clock) in first node N1 uses the values of CF₁ and CF₂ in the received reply message to calculate offsetFromMaster and meanPathDelay as follows:

$$meanPathDelay = \frac{( {T}_{4} - {T}_{3} ) + ( {T}_{2} - {T}_{1} ) - C {F}_{1} - C {F}_{2}}{2} \qquad ( 3 )$$

$$offsetFromMaster = {T}_{2} - {T}_{1} - meanPathDelay \qquad ( 4 )$$

The complete set of PTP information (i.e., T₁, T₂, T₃, T₄, CF₁, CF₂) may be referred to as a “measurement.” Each round-trip message exchange produces a single such measurement, which in the static case—that is, in which N1, N2, N3, and N4 are stationary relative to one another—is sufficient for N1 to fully calculate offsetFromMaster and meanPathDelay using equations (3) and (4), which include corrections for any queuing delays at transparent clocks (relay nodes) between N1 and N4, e.g., at N2 and N3 in the nonlimiting example described with reference to FIG. 3. To simplify theoretical understanding, a detailed discussion is omitted herein of additional PTP messages that are sometimes required to convey PTP information from where it is measured to where it is required to complete this calculation. For example, the FOLLOW_UP or DELAY_RESP messages defined in the PTP specification are sometimes required to convey information from the PTP master to the PTP slave. In effect, such messages are ordinary network packets; they are not modified in transit by transparent clocks because they are not timing-critical components of the TWTTR exchange and do not require precise timestamps.

### 4. Mobile Delay Compensation

This section describes example complications that may arise if nodes moving relative to one another tried to exchange TWTTR messages using PTP. Conventional TWTTR calculations such as described with reference to equations (1) and (2), such as PTP processing described with reference to equations (3) and (4), rely on the assumption that path-delays are constant and symmetric. Mobile networks violate both assumptions, which is believed to have precluded the use of PTP in mobile networks to date.

In mobile networks, some or all of the network nodes are in relative motion. The motion of network nodes means that path-delay changes over time, and that path-delay of a message and its reply are no longer equal. Because the critical assumptions of PTP are violated, naïve application of the conventional PTP calculations would result in invalid meanPathDelay and offsetFromMaster calculations. For this reason, PTP is believed to have been limited to use in static applications.

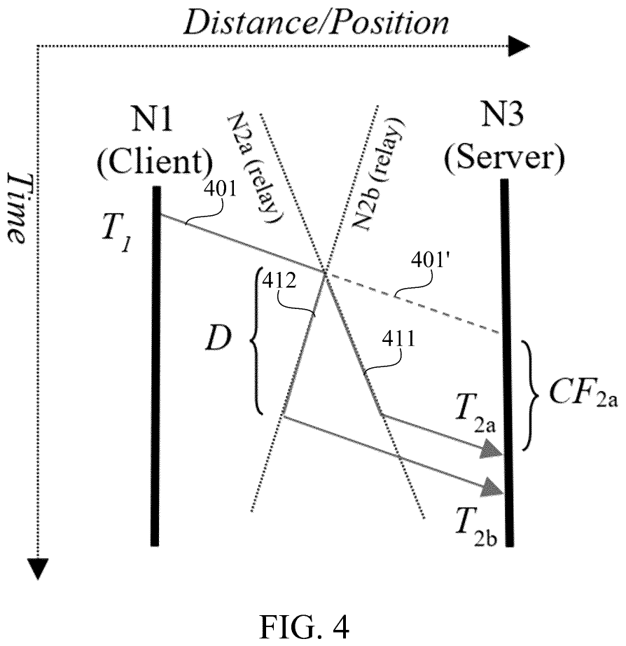

As recognized by the present inventor, TWTTR may be modified to additionally use velocity information to calculate path delays and time offsets in multi-hop networks that include nodes moving relative to one another. Illustratively, FIG. 4 illustrates an example manner in which motion of a relay node affects PTP messaging in a multi-hop computer network. In this example, the network includes three nodes: N1 (client, ordinary clock), N2 (transparent clock), and N3 (server, ordinary clock), which are located at different positions and communicating wirelessly. For simplicity, the client N1 and server N3 are stationary ground stations. However, relay node N2 is on a vehicle (e.g., spacecraft, satellite, airplane, or the like) which is moving at an unspecified, relatively fixed velocity while acting as a PTP transparent clock. FIG. 4 illustrates that relay node N2 may have one of two different hypothetical velocities, represented as either N2a or N2b.

Similarly as described with reference to FIGS. 1 and 3, client N1 sends a first message (e.g., request message) at time T1. The first message is received by relay node N2, which retains the message for a fixed (but unknown) delay D before relaying the message. The first message reaches server N3 at time T2. If the fixed delay D at node N2 is zero, then the dotted line 401′ indicates the first message's hypothetical position-vs-time if it had continued propagating toward node N3 at the normal speed of that message's propagation through the transmission medi(a), unhindered by the incidental delay that node N2 introduces.

However, in this example, relay node N2 is either traveling at a first (unknown) velocity (N2a) or at a second (unknown) velocity (N2b). When D is nonzero, the motion of relay node N2a or N2b changes the total path-delay of the message received by N3. For example, in FIG. 4, the queuing delay caused by N2 traveling at the first velocity (N2a) is indicated by nearly-vertical segment 411 in the position-vs-time curve 401 for the first message, and the queuing delay caused by N2 traveling at the second velocity (N2b) is indicated by nearly-vertical segment 412 in the position-vs-time curve 401 for the first message. Although N2 begins transmission at the same time regardless of that node's velocity, the time at which N3 receives the first message changes based on the velocity of the relay node. For example, when N2 is travelling at the first velocity (N2a), N3 receives the message at time T₂ₐ. Or, for example, when N2 is traveling at the second velocity (N2b), N3 receives the message at a different time T_{2b}. The timing of reply messages from N3 to N1 will be similarly affected by the velocity of N2.

Accordingly, the time at which an ordinary clock (e.g., client or server) receives a message varies depends on both the queueing delays and velocity of intervening relay node(s). While the simplified example illustrated in FIG. 4 includes a single relay node N2, in multi-hop computer networks with even more relay nodes, some or all of which are moving relative to other one or more nodes in the network, the relative velocities of such nodes similarly may shift the time at which the ordinary clocks receive messages, and thus cause errors.

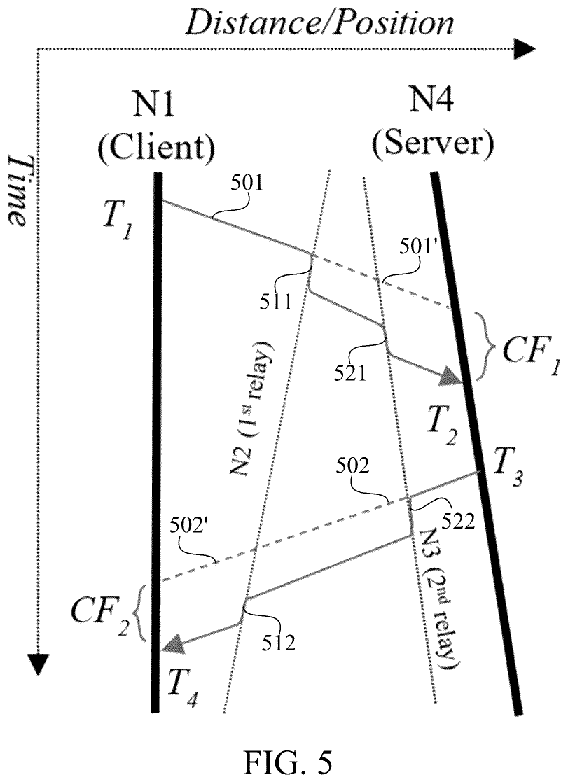

For example, FIG. 5 illustrates an example manner in which relative motion of some or all nodes affects PTP messaging in a multi-hop computer network. In this example, the network includes four nodes: N1 (client, ordinary clock), N2 (transparent clock), N3 (transparent clock), and N4 (server, ordinary clock), which are located at different positions and communicating wirelessly. N2, N3, and N4 are all moving relative to one another and also moving relative to N1. In some examples, one or more of N1, N2, N3, and N4 may be stationary, while in other examples all of the nodes may be moving relative to a point of reference.

Similarly as described with reference to FIGS. 1, 3, and 4, client N1 sends a first message (e.g., request message) at time T1. The first message is received by relay node N2, which retains the message for an unpredictable delay before relaying the message to relay node N3, which then retains the message for an unpredictable delay before relaying the message to node N4. Dotted line 501′ indicates the first message's hypothetical position-vs-time if it had continued propagating toward node N4 at the normal speed of that message's propagation through the transmission medi(a), unhindered by the unpredictable delays that nodes N2 and N3 introduce; and the dotted line 502′ indicates the second message's hypothetical position-vs-time if it had continued propagating toward node N1 at the normal speed of that message's propagation through the transmission medi(a), unhindered by the unpredictable delays that nodes N3 and N2 introduce.

Similarly as described with reference to FIG. 4, relay node N2 is traveling at a first (unknown) velocity relative to N1, N3, and/or N4, and relay node N3 is traveling at a second (unknown) velocity relative to N1, N2, and/or N4. The relative motion of relay nodes N2 and N3 change the total path-delay of the message transmitted from N1 to N4. For example, in FIG. 5, the queuing delay caused by N2 traveling at the first relative velocity is indicated by vertical segment 511 in the position-vs-time curve 501 for the first message, and the queuing delay caused by N3 traveling at the second relative velocity is indicated by vertical segment 521 in the position-vs-time curve 501 for the first message. N4 receives the first message at time T₂, and transmits the second message at time T₃ as shown in FIG. 4.

The relative motion of relay nodes N2 and N3 similarly change the total path-delay of the second message transmitted from N4 to N1. For example, in FIG. 5, the queuing delay caused by N3 traveling at the second relative velocity is indicated by vertical segment 522 in the position-vs-time curve 502 for the first message, and the queuing delay caused by N2 traveling at the first relative velocity is indicated by vertical segment 512 in the position-vs-time curve 502 for the second message. N1 receives the second message at time T₄. It may be seen from FIG. 5 that because of the motion of nodes N2 and N3 relative to nodes N1 and/or N4, the total path-delay of the first message is different than the total path-delay of the second message. That is, the path-delays of the first and second messages are asymmetric.

The present inventor recognized that velocity information may be used to offset the effect of relative node movement in a multi-hop computer network. For example, static-PTP transparent clocks increment CF based solely on elapsed time D inside the transparent clock (i.e., the difference between the timestamp for when that transparent clock receives the message and the timestamp for when that transparent clock transmits that message). The present inventor recognized that it would be more accurate for mobile-PTP transparent clocks to increment CF by the predicted net delay experienced by the next-hop recipient, and that such net delay may be predicted using velocity information. Under such a circumstance, the CF at the end of a multi-hop path would more accurately reflect the end-to-end impact of relative node velocity in a mobile network, e.g., the difference along the vertical axis in FIG. 4 between curve 401 and line 401′, the difference along the vertical axis in FIG. 5 between curve 501 and line 501′, and the difference along the vertical axis in FIG. 5 between curve 502 and line 502′.

As provided herein, the time-varying next-hop path delay is defined by function P(t). The time-varying path delay is unknown and must be estimated or modeled. During the elapsed time D, the time-varying path delay changes by an amount ΔP given by:

$$Δ P ≡ P ( {t}_{next} ) - P ( {t}_{prev} ) \qquad ( 5 )$$

where P(t) is the next-hop path-delay as a function of time, tₚᵣₑᵥ is the transparent clock's message ingress time, tₙₑₓₜ is the transparent clock's message egress time.

Given a model for ΔP, each transparent clock (relay node) applies the revised CF increment function that reflects the change in the next-hop path delay:

$$C {F}^{′} ≡ C F + D + Est ( Δ P ) \qquad ( 6 )$$

where D is the transparent clock's elapsed time delay (i.e., D=tₙₑₓₜ−tₚᵣₑᵥ), Est(ΔP) is the estimated change in path-delay between the ingress and egress times, CF is the correctionField of the received message, and CF′ is the modified (incremented) correctionField of the transmit message to the next hop.

Under this revised increment function, each transparent clock calculates CF′ by adding the delay D plus a correction Est(ΔP) to account for the next hop's motion relative to that transparent clock. In the case where all nodes are stationary, P(t) is a constant, so the difference ΔP is zero, and the increment function simplifies to CF′=CF+D. This is identical to the increment function described by the PTP specification, so the revised increment is backwards-compatible with the conventional static case.

In the case where some nodes are in motion, the correction term ΔP also indicates the magnitude of the timestamp error that would be incurred by using a naïve transparent clock that does not correctly compensate for motion effects. To correctly compensate for these effects, each transparent clock must estimate or predict ΔP and apply the revised CF increment function. As one nonlimiting example, consider a satellite crosslink with constant range-rate of v=10 km/s, which is equivalent to dP/dt=v/c≈33 s/s. If the transparent clock has a delay of D=10 ms, this yields a correction term ΔP≈330 ns.

In the circumstance where P(t) can be approximated by a constant derivative, a transparent clock may predict ΔP by estimating the fixed (unknown) range-rate parameter P′≈dP/dt. As one nonlimiting example, this yields the revised CF increment function:

$$Δ P \approx Est ( Δ P ) = {P}^{′} D \qquad ( 7 )$$

$$C {F}^{′} = C F + D + {P}^{′} D \qquad ( 8 )$$

When D is relatively small (e.g., 1-10 ms), the constant rate assumption is expected to be a good approximation at sub-nanosecond scale. When D is larger or additional precision is required, each transparent clock may use higher-order polynomials or other approximations. For example, a design might assume constant acceleration instead of constant velocity, resulting in a quadratic model for P(t), requiring each transparent clock to estimate both range-rate and range-acceleration. Simple approximations are helpful for affordable implementation of mobile transparent clocks because the CF increment function is often implemented in ASIC hardware or FPGA gateware. Complex arithmetic functions are resource-intensive on such platforms, but simple multiply or multiply-accumulate operations are relatively inexpensive.

### 5. Range-Rate Measurement

As recognized by the present inventor, modifying PTP to correct errors such as described in Section 4 allows the modified PTP to be implemented in a mobile network, whereas conventional PTP is believed to have previously limited to use in a static network. Although several examples provided herein are described with reference to PTP terms, it will be appreciated that the present systems and methods are not so limited, and indeed may be used to measure range-rate in any system utilizing messaging, such as TWTTR messaging.

More specifically, as provided herein, multi-hop networks such as described with reference to FIG. 2 may be configured to additionally measure the time-derivative of the total path-delay for a multi-hop path between any two endpoints (i.e., the total range-rate), and to use such time-derivative to offset errors caused by nodes' relative motion in the network. As recognized by the present inventor, relay nodes in the network may be configured to measure and quantify those nodes' respective Doppler shifts, and any or all node(s) may be configured to use the cumulative Doppler shift across the network to calculate a correction for such motion. For single-hop paths, the time-derivative of the total path-delay is simply the range-rate discussed in the previous section.

Consider again the multi-hop network illustrated in FIG. 2, where N1, N2, and N3 respectively and independently represent a satellite, vehicle, or ground station connected to a wide-area network. A practical network will likely have many more branches than shown in FIG. 2, with a mesh of many nodes with many modems at each node. This simplified example has been pruned for clarity, showing only the direct path over two wireless hops. Like the scenarios described in Section 4, some or all of the nodes are moving relative to one another. Each unidirectional communication segment in the network has a transmit symbol rate Fₜₓ (the rate observed at the transmitter) and a receive symbol rate Fᵣₓ (i.e., the rate observed at the receiver). From either of these quantities, we define normalized symbol rate Fₙ, i.e., the observed transmit or receive symbol rate divided by the nominal symbol rate for that link. In FIG. 2, normalized symbol rates F₁ through F₁₂ are numbered sequentially for the round-trip path through the network. For each normalized symbol rate,

$${F}_{n} ≡ \frac{{F}_{o bserved}}{{F}_{nominal}} \approx 1 \qquad ( 9 )$$

For any mobile optical or radio link, the Doppler effect causes a frequency difference between the observed transmit and receive symbol rates. Ignoring relativistic effects and assuming constant relative velocity, the Doppler ratio 6 may be expressed as:

$$δ ≡ \frac{{F}_{r x}}{{F}_{t x}} = ( 1 + {P}^{′} ) = ( 1 + v / c ) \qquad ( 10 )$$

where Fₜₓ is the transmit symbol rate, Fᵣₓ is the received symbol rate, P′ is the path-delay rate, v is the range-rate, and c is the speed of light in the relevant medium.

Note that Doppler-shifted symbol rates Fₜₓ and Fᵣₓ are observed at opposite ends of the wireless channel (e.g., at the respective nodes at the ends of a communication segment shown in FIG. 2). As recognized by the present inventor, because the nodes are separated by a relatively large distance and have clocks running independently of one another, the nodes are limited to using different local frequency references to calculate the nodes' own Doppler ratio, but the nodes are unable to make precise observations regarding the network, as a whole, based solely on their own local frequency references. Because a node's direct observation of range-rate depends on accurate local references, but the time-transfer accuracy relies on range-rate information for the network as a whole, this seemingly creates a chicken-and-egg paradox. The present inventor discovered how to use Doppler shifts to resolve this seeming paradox.

Consider again the multi-hop network illustrated in FIG. 2. Each node in this network has a local reference oscillator. Although the frequency of a real oscillator may wander over time, during a relatively a short time-window the oscillator frequency is approximately constant. Under this simplification, the local reference frequency γₘ may be adequately expressed as the ratio of the oscillator's actual and nominal frequencies:

$${γ}_{m} ≡ \frac{{REF}_{a ctual}}{{REF}_{nominal}} \approx 1 \qquad ( 11 )$$

In the present systems and methods, the nodes are configured to use their local reference oscillators to derive all transmit signals originating from that node. Local devices can meet this constraint by distributing a reference signal or by using Synchronous Ethernet. Additionally, the modems may have a fixed internal delay and do not retime signals. That is, the received symbol rate at the network switch input or output accurately reflects the symbol rate at the antenna or optical aperture. Modems that retime the signal may be used in the present systems and methods, but may be configured to behave as an additional transparent clock such as described herein.

For signals within the same node, the transmit and receive frequencies are identical because they are derived from the same local reference within a sufficiently close time for the assumption in equation (11) to hold. For signals that a given node receives from another node, the received frequency of that signal is modified by the Doppler effect. As such, the normalized symbol rates F₁ through F₁₂ illustrated in FIG. 2 may be described in terms of δₙ and γₘ:

$${F}_{1} = {γ}_{1} \qquad ( 12 )$$

$${F}_{2} = {γ}_{1} \qquad ( 13 )$$

$${F}_{3} = {γ}_{1} {δ}_{1} \qquad ( 14 )$$

$${F}_{4} = {γ}_{2} \qquad ( 15 )$$

$${F}_{5} = {γ}_{2} {δ}_{2} \qquad ( 16 )$$

$${F}_{6} = {γ}_{3} \qquad ( 17 )$$

$${F}_{7} = {γ}_{3} \qquad ( 18 )$$

$${F}_{8} = {γ}_{3} \qquad ( 19 )$$

$${F}_{9} = {γ}_{3} {δ}_{2} \qquad ( 20 )$$

$${F}_{10} = {γ}_{2} \qquad ( 21 )$$

$${F}_{11} = {γ}_{2} {δ}_{1} \qquad ( 22 )$$

$${F}_{12} = {γ}_{1} \qquad ( 23 )$$

However, parameters δₙ and γₘ cannot be observed directly. The remainder of this section describes how to approximate the sum of all δₙ terms from parameters that can be observed locally. The described method does not require estimation of γₘ.

As provided herein, each network switch acts similarly as a mobile-PTP transparent clock as described above and in the PTP specification. However, in addition to the normal operation of a static-PTP transparent clock, the present mobile-PTP transparent clocks are configured also to calculate the received symbol rate Fₙ for each incoming network link. For practical reasons described elsewhere herein, the transparent clocks cannot measure Fₙ directly, and so instead are configured to measure the frequency ratio φₙ in relation to the local frequency reference γₘ, e.g., as follows:

$${φ}_{n} ≡ \frac{{F}_{n}}{{γ}_{m}} \approx 1 \qquad ( 24 )$$

In the systems and methods provided herein, a first endpoint (e.g., client or first ordinary clock, such as at node N1 illustrated in FIG. 2) generates a request message and initializes a dopplerField (DF) in the request message. Relay nodes (e.g., transparent clocks, such as at node N2 illustrated in FIG. 2) in the multi-hop computer network transmit the request message to the second endpoint (e.g., server or second ordinary clock, such as at node N3 illustrated in FIG. 2). As provided herein, the relay nodes increment the value of DF in the request message. In some examples, each relay node increments DF by a value ΔDF which is equal to the difference between the ingress frequency ratio φₚᵣₑᵥ and the egress frequency ratio φₙₑₓₜ, which difference may be expressed as follows:

$$Δ D F = D {F}^{′} - DF = {φ}_{p r e v} - {φ}_{next} \qquad ( 25 )$$

Each relay node calculates φₚᵣₑᵥ and φₙₑₓₜ using its own locally-measured frequency offsets. Methods for frequency estimation in relation to a local frequency reference are widely described in prior art, with examples including the simple frequency counter or the vernier phase locked loop (US 2024/0204788 A1, the entire contents of which are incorporated by reference herein). Preferred embodiments should use frequency estimation techniques with a precision finer than one part-per-billion.

Responsive to receiving the request message, including DF which has been incremented by each relay node along the path from the first endpoint, the second endpoint then generates a reply message to be sent to the first endpoint that includes a DF that echoes (is the same value as) the DF in the received request message. For example, because each relay node increments DF in the request message, the DF received by the second endpoint is the same as the DF transmitted by the last relay node in the network path. The relay nodes in the network then respectively increment the value of the reply message's DF as those relay nodes transmit the reply message to the first endpoint, similarly as described for the DF of the request message, e.g., with reference to equation (25).

When the response message reaches the PTP client, the client uses the final received DF (which may be referred to as DF_{fin}) to derive the total range-rate. In the two-hop example of FIG. 2, DF_{fin} may be expressed as the sum of six terms, i.e., one for each relay node (e.g., transparent clock) in the round trip from the first endpoint to the second endpoint and back:

$$D {F}_{fin} ≡ \sum Δ DF = \sum [ \begin{matrix}{φ}_{1} - {φ}_{2} \\ {φ}_{3} - {φ}_{4} \\ {φ}_{5} - {φ}_{6} \\ {φ}_{7} - {φ}_{8} \\ {φ}_{9} - {φ}_{10}\end{matrix} ] \qquad ( 26 )$$

By algebraic substitution in light of equation (24), equation (26) may be expressed as:

$$D {F}_{fin} = \sum [ \begin{matrix}{F}_{2} / {γ}_{1} - {F}_{2} / {γ}_{1} \\ {F}_{3} / {γ}_{2} - {F}_{4} / {γ}_{2} \\ {F}_{5} / {γ}_{3} - {F}_{6} / {γ}_{3} \\ {F}_{7} / {γ}_{3} - {F}_{8} / {γ}_{3} \\ {F}_{9} / {γ}_{2} - {F}_{10} / {γ}_{2} \\ {F}_{11} / {γ}_{1} - {F}_{12} / {γ}_{1}\end{matrix} ] . \qquad ( 27 )$$

By algebraic substitution in light of equation (12) through equation (23), equation (27) may be rewritten as:

$$D {F}_{fin} = \sum [ \begin{matrix}1 - 1 \\ {γ}_{1} {δ}_{1} / {γ}_{2} - 1 \\ {γ}_{2} {δ}_{2} / {γ}_{3} - 1 \\ 1 - 1 \\ {γ}_{3} {δ}_{2} / {γ}_{2} - 1 \\ {γ}_{2} {δ}_{1} / {γ}_{1} - 1\end{matrix} ] . \qquad ( 28 )$$

By algebraic manipulation, equation (28) may be rewritten as:

$$D {F}_{fin} = {δ}_{1} ( \frac{{γ}_{1}}{{γ}_{2}} + \frac{{γ}_{2}}{{γ}_{1}} ) + {δ}_{2} ( \frac{{γ}_{2}}{{γ}_{3}} + \frac{{γ}_{3}}{{γ}_{2}} ) - 4. \qquad ( 29 )$$

Although a generalized proof is beyond the scope of the present disclosure, the following summation is expected to hold for the general case with any number of hops:

$$D {F}_{fin} = \sum [ {δ}_{m} ( \frac{{γ}_{prev}}{{γ}_{next}} + \frac{{γ}_{next}}{{γ}_{prev}} ) - 2 ] \qquad ( 30 )$$

where δₘ is the Doppler ratio for the mth hop, and γₚᵣₑᵥ and γₙₑₓₜ are the normalized local reference frequencies for the nodes on each side of that hop.

From equation (11)'s approximation that all γₘ≈1, therefore, DF_{fin} may be expressed as being approximately equal to the sum of all δₘ terms, as follows:

$$D {F}_{fin} \approx 2 \sum ( {δ}_{m} - 1 ) = 2 \sum {P}_{m}^{′} . \qquad ( 31 )$$

As recognized by the present inventor, DF_{fin} may be used as a heuristic that is directly proportional to the total range-rate defined at the start of this section. Additionally, the present inventor recognized that the opposing ratios in each summation term (e.g., γₚᵣₑᵥ/γₙₑₓₜ plus its inverse) mitigate much of the variation in local reference frequencies. Illustratively, for two consecutive relay nodes with respective reference oscillators having a relatively modest accuracy of ±100 ppm, the worst-case deviation in the sum-of-opposed-ratios is expected to be approximately ±20 ppb. For two consecutive relay nodes with respective reference oscillators having an improved accuracy of ±10 ppm, the worst-case deviation in the sum-of-opposed-ratios is just ±0.2 ppb.

As a result, the present systems and methods yield a relatively accurate measurement of total range-rate even if the local reference oscillators have poor initial accuracy. This resolves the seeming chicken-and-egg paradox for bootstrapping the network from an unknown initial state. As the present systems and methods operate, local oscillators throughout the network may be disciplined to yield improved reference accuracy, thereby yielding improved range-rate accuracy, thereby yielding further improved reference accuracy, and so forth in a virtuous cycle.

The method described in this section measures the total range-rate along a given path. (i.e., The sum of range-rate terms P′ along each individual hop.) To measure range-rate for a specific hop, the simplest method is to measure paths with a single hop. Another method is to measure paths with several static hops and a single mobile hop, i.e., when all range-rates are zero except for a single wireless link with unknown range-rate, the total range-rate must be equal to the unknown range-rate. Another method is to combine measurements of total range-rate across different overlapping network path(s), to algebraically derive range-rate estimates for specific hop(s) along those paths. For example, the range-rate of hop (A-B) is equal to the difference between total range-rate along path (A-B-C-D) and total range-rate along path (B-C-D)

In a nonlimiting example, consider a network of vehicular nodes, each vehicle comprising a network router acting as a PTP transparent clock, a PTP ordinary clock, and a plurality of wireless communication terminals connected to the router. At regular intervals, the PTP ordinary clock performs TWTTR with the PTP ordinary clock aboard each neighboring vehicle. Each TWTTR exchange follows a multi-hop path from the first ordinary clock, through the first transparent clock, through the wireless link, through the second transparent clock, finally reaching the second ordinary clock. Since the wireless link constitutes the only unknown range-rate along this path, the ordinary clock can solve for range-rate P′ to each neighboring vehicle. Once the ordinary clock communicates that information to the transparent clock through any suitable network message, then the transparent clock can apply the next-hop update ΔP=P′D required for the revised CF increment described in Section 4.

### 6. Doppler-TLV

As recognized by the present inventor, a dopplerField (DF) can be added to TWTTR messages and used to calculate the range-rate of the mobile network. In nonlimiting examples in which the mobile network implements PTP, the dopplerField (DF) can be added to the PTP messages in a backwards-compatible fashion.

For example, the IEEE-1588 specification for PTP includes mechanisms for vendor-specific extensions, also referred to as “TLVs” because they consist of Type, Length, and Value (TLV) fields. TLVs allow additional interpretation of metadata appended to any given PTP message. In nonlimiting examples in which the mobile network implements PTP, the PTP may be modified in a manner such as provided herein. For example, velocity-based updates may be applied when incrementing the CF of standard PTP messages, without the use of a new message field relative to those set forth in the PTP protocol, in a manner such as described with reference to Section 4, for example, the addition of the ΔP term of equation (5) or equation (7). Additionally, or alternatively, Doppler shifts may be measured by adding DF to PTP messages as a new TLV, and may be incremented to provide range-rate measurements which are not currently part of the PTP specification, in a manner such as described with reference to Section 5.

In some examples, DF may use a fixed-point representation that is similar to, or the same as, the standard CF in PTP. For example, similarly as a CF offset of +1.0 ns is represented by the quantity 2¹⁶=65,536 least significant bits (LSBs), a frequency difference (φₙ−1) of one part per billion (i.e., +1.0 ns/s) may be represented by the quantity 2¹⁶=65,536 LSBs in the DF. Using this scaling factor, a 48-bit signed variable yields a range-rate resolution of 4.6 μm/s and a maximum velocity exceeding the speed of light. This range is expected to be sufficient for all currently anticipated practical applications.

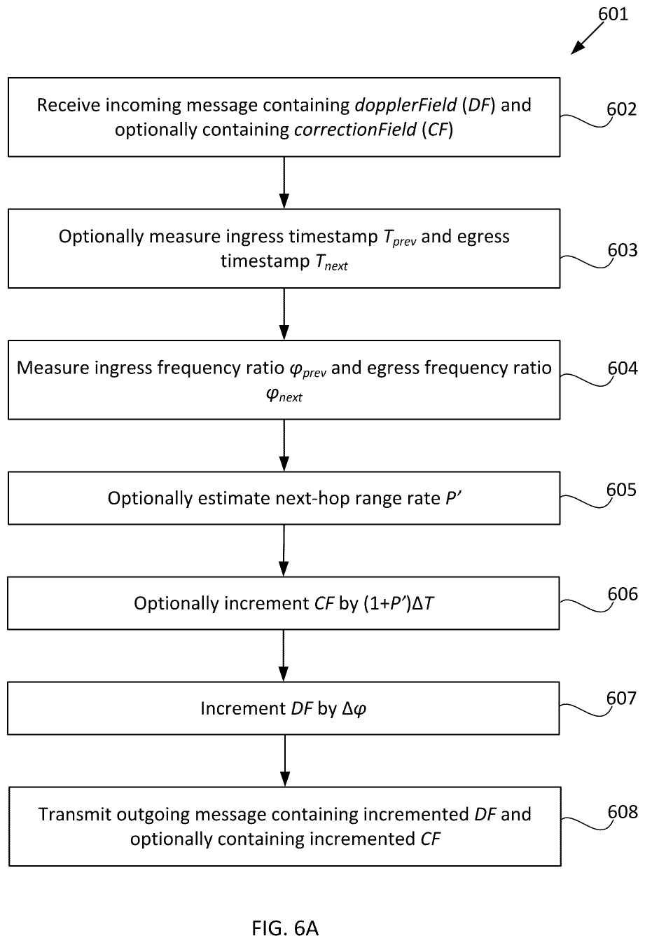

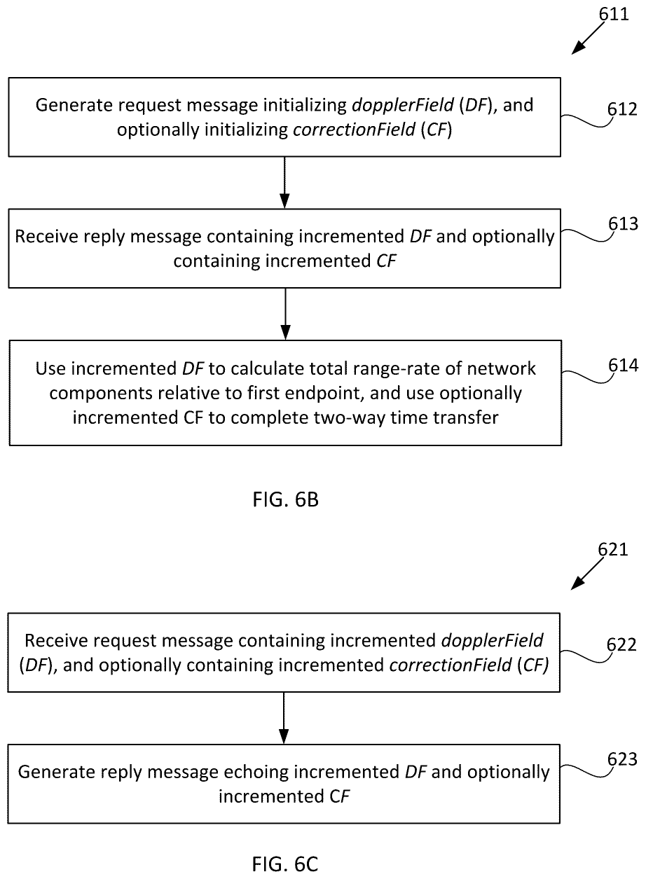

FIG. 6A illustrates an example flow of operations in a method 601 implemented by a relay node (e.g., transparent clock) for TWTTR using Doppler shifts, according to some examples provided herein. Method 601 may include receiving an incoming message containing DF, and optionally containing CF (operation 602). The incoming message which is processed using method 601 may be or include a request message, or may be or include a reply message. Method 601 further may include measuring an ingress frequency ratio φₚᵣₑᵥ and egress frequency ratio φₙₑₓₜ of the incoming message (operation 604) as defined in equation (24). Method 601 further may include incrementing DF by a difference between the ingress frequency ratio φₚᵣₑᵥ and that egress frequency ratio φₙₑₓₜ (operation 607). That is, the relay node may perform the calculation described with reference to equation (25). Method 601 may include transmitting an outgoing message containing the incremented DF (operation 608). The relay node may transmit the outgoing message to the next node in the network, whether the node is an endpoint (e.g., client or server) or another relay node. Each additional relay node in the network similarly implement method 601, using operations 604 and 607 to increment the incremented DF that it receives in operation 602.

In nonlimiting examples in which the incoming message optionally is a PTP message (such as a DELAY_REQ or SYNC message), the message also contains CF. In such examples, operations 603, 605, and 606 optionally may be implemented, and the relay node may be referred to as a transparent clock. For example, method 601 further may include measuring the ingress timestamp Tₚᵣₑᵥ and egress timestamp Tₙₑₓₜ of the incoming message (operation 603). Method 601 further may include estimating the next-hop range rate P′ (operation 605). For example, each relay node may estimate range-rate to neighboring nodes using the method described in the last two paragraphs of Section 5. Method 601 further may include incrementing CF using the next-hop range rate and a difference between the ingress timestamp and the egress timestamp of the request message, e.g., may increment CF by D+P′D (operation 606). For example, the relay node may perform the calculation described with reference to equation (8). The message that the relay node transmits in operation 608 further may include the incremented CF obtained using operations 603, 605, and 606.

In examples of method 601 in FIG. 6A in which the request message is not a PTP message, the incoming message received in operation 602 need not necessarily contain CF, the outgoing message transmitted in operation 608 need not necessarily contain the incremented CF′, and operations 603, 605, and 606 may be omitted. Additionally, it will be appreciated that operations may be performed in any suitable order different than that shown in FIG. 6A.

FIG. 6B illustrates an example flow of operations in a method 611 implemented by a first endpoint (e.g., client) for TWTTR using Doppler shifts, according to some examples provided herein. Method 611 may include generating a request message initializing DF, and optionally initializing CF (operation 612). Method 611 may include receiving a reply message containing incremented DF, and optionally containing incremented CF (operation 613). For example, the first endpoint may be a master clock initiating a TWTTR exchange at operation 612 by generating a SYNC message, and the master clock may receive a DELAY_REQ message at operation 613 in reply from a slave clock. Or, for example, the first endpoint may be a slave clock initiating a TWTTR exchange at operation 612 by generating a DELAY_REQ message, and the slave clock may receive a SYNC message at operation 613 in reply from a master clock. Method 611 may include using the incremented DF to calculate the total range-rate of network components relative to the first endpoint (operation 614). In nonlimiting options in which the reply message includes an incremented CF, operation 614 further may include using the incremented CF to complete two-way time transfer, for example calculating offsetFromMaster using the method recommended by the PTP specification, then using that parameter to calibrate or discipline a local clock. In nonlimiting options in which the reply message includes an incremented DF, then DF may be used to calculate the total range-rate, and the total range-rate may be used to measure next-hop range-rate P′. In nonlimiting options in which the reply message includes an incremented CF and an incremented DF, then the total range and total range-rate may be used as an input to a positioning and navigation system. For example, the range and range-rate measured from a mobile handset to at least three fixed nodes with known coordinates is sufficient to trilaterate the three-dimensional position and velocity of the mobile handset. In another example, the collection of range and range-rate between many pairs of satellites in an orbital constellation, accumulated over time, are sufficient to solve for the orbital parameters of each satellite.

FIG. 6C illustrates an example flow of operations in a method implemented by a second endpoint (e.g., server) for TWTTR using Doppler shifts, according to some examples provided herein. Method 621 may include receiving a request message containing incremented DF, and optionally containing incremented CF (operation 622). Method 621 may include generating a reply message containing the incremented DF, and optionally containing the incremented CF (operation 623). For example, the second endpoint may be a slave clock generating a DELAY_REQ message at operation 623 that echoes the incremented DF and optional incremented CF in a SYNC message that the slave clock receives at operation 622. Or, for example, the second endpoint may be a master clock generating a SYNC message at operation 623 that echoes the incremented DF and optional CF in a DELAY_REQ message that the master clock receives at operation 622.

The operations respectively described with reference to methods 601, 611, and 621 may be implemented by any suitable nodes in a mobile network, in any suitable order. Illustratively, at operation 612 of method 611, a first endpoint (e.g., client) may generate, and may transmit, a request message initializing DF. Then, a first relay node may receive the incoming message (here, the request message) at operation 602 of method 601; may measure the ingress frequency ratio and egress frequency ratio, at operation 604 of method 601; may increment DF by a difference between the ingress frequency ratio and egress frequency ratio, at operation 607 of method 601; and may transmit the outgoing message containing the incremented DF, at operation 608 of method 601. Any suitable number of additional relay nodes (e.g., between zero and 100 additional relay nodes) between the first endpoint and the second endpoint may perform similar operations as described for the first relay mode, e.g., each such relay node may receive the incoming message at operation 602 of method 601 from an earlier node; may measure the ingress frequency ratio and egress frequency ratio, at operation 604 of method 601; may increment DF by a difference between the ingress frequency ratio and egress frequency ratio, at operation 607 of method 601; and may transmit the outgoing message containing the incremented DF, at operation 608 of method 601. Then, at operation 622 of method 621, a second endpoint may receive the request message containing the incremented DF. Then, at operation 623 of method 621, the second endpoint may generate a reply message echoing the incremented DF. Each relay node between the second endpoint and the first endpoint may receive the incoming message (here, the reply message) at operation 602 of method 601; may measure the ingress frequency ratio and egress frequency ratio, at operation 604 of method 601; may increment DF by a difference between the ingress frequency ratio and egress frequency ratio, at operation 607 of method 601; and may transmit the outgoing message containing the incremented DF, at operation 608 of method 601. Then, at operation 613 of method 611, the first endpoint may receive the reply message containing the incremented DF. Then, at operation 614 of method 611 the first endpoint may use the incremented DF to calculate the total range-rate of network components relative to the first endpoint. Although not specifically mentioned, the CF optionally may be contained in the messages and processed in a manner such as described with reference to FIGS. 6A-6C.

As yet another alternative, methods 601, 611, and 621 optionally may omit the processing of DF, and may process CF in the described manner. That is, either CF alone, DF alone, or both CF and DF may be processed in the described manner.

As recognized by the present inventor, DF and the use thereof may be readily integrated into PTP. Accordingly, DF and the use thereof may someday be considered for incorporation into a future version of the IEEE-1588 specification. While FIGS. 6A-6C may be described with reference to certain fields and calculations used in PTP, it should be appreciated that the present methods are not limited to use in PTP and are not limited to use in the IEEE-1588 specification.

### 7. Doppler-PTP Prototype

This section describes the implementation of a prototype for an end-to-end mobile-PTP system, applying the fields and calculations described in Section 4 and Section 5 to perform the operations described in Section 6.

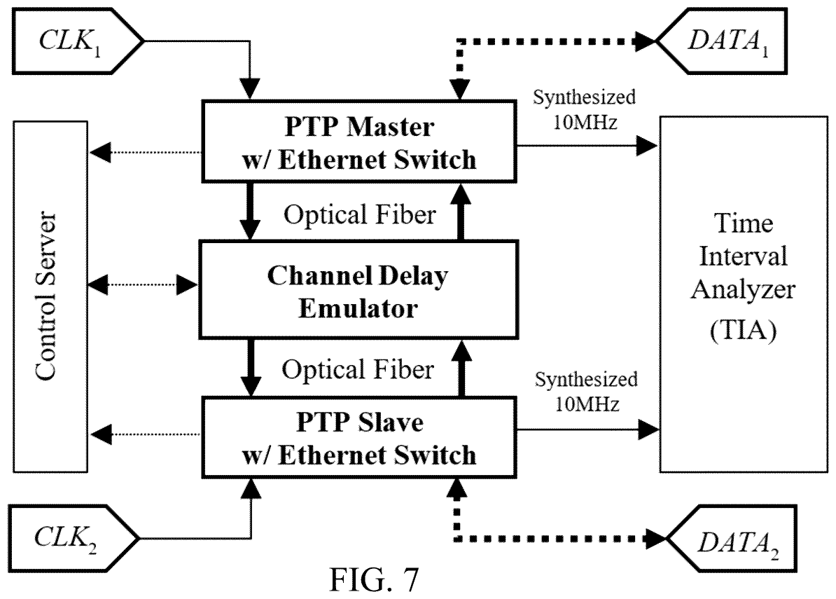

FIG. 7 schematically illustrates an example system implementing Doppler-PTP, according to some examples provided herein. More specifically, the prototype system under test included a PTP Master, a Channel Delay Emulator (CDE), and a PTP Slave as shown in FIG. 7. The complete system may be referred to as the Time and Ranging Instrument with Optical Delay Emulation (TRIODE).

Each endpoint hosted a PTP ordinary clock implemented using an FPGA. One endpoint acted as the PTP Master and the other endpoint acted as the PTP Slave. Each endpoint's internal clock was an all-digital, software-disciplined, numerically controlled oscillator (NCO) driven by an independent free-running reference oscillator (CLK1, CLK2).

Each endpoint FPGA also hosted a SatCat5 Ethernet switch with several asynchronous ports, acting as a mobile-PTP transparent clock. The switch carried a mixture of PTP messages and optional passthrough traffic (DATA1, DATA2) from other sources, to test the PTP network's ability to tolerate congestion.

Gateware and software on the endpoint FPGAs exchanged PTP messages to discipline the PTP Slave NCO, attempting phase-lock to the PTP Master NCO. Each NCO drove a 10 MHz digital synthesizer. A time-interval analyzer (TIA) measures the Allan variance and its derivatives (i.e., ADEV, MDEV, TDEV) between the two synthesized outputs. Without discipline, the time-deviation of these outputs matched that of the free-running external references (CLK1, CLK2). With discipline enabled, the phase-locking accuracy of the two outputs indicated the end-to-end performance of the time-transfer system.

The two endpoints were linked by asynchronous gigabit Ethernet. The signals were carried over fiber-optic cables using Small Form-factor Pluggable (SFP) electro-optical transceiver modules. The selected SFP modules were direct electro-optical transducers that do not retime the Serial Gigabit Media Independent Interface (SGMII) signal.

The use of asynchronous Ethernet complicates precise phase and frequency measurements, but asynchronous operation is required for mobile PTP. A VERDACT circuit was used to allow precise cross-clock timestamping and normalized frequency measurements (e.g., φₙ). Operation and performance of the VERDACT circuit is described in US Patent Publication No. 2024/0204788 to Utter; and Utter, “Beyond DDMTD—Sub-picosecond timestamps for asynchronous clocks,” IEEE Access 11: 145801-145812 (2023). Briefly, VERDACT uses a pair of synthetic clocks derived from the local reference (CLK1, CLK2) to allow sub-picosecond timestamp accuracy and commensurate frequency precision, even over short observation windows circa 50 ms.

The channel delay emulator (CDE) was inserted between the two PTP endpoints. Because orbital velocities cannot be duplicated in a laboratory setting, the CDE emulated the variable channel delays that would be experienced by satellites in that environment. The CDE operated by sampling each incoming signal at 10 GHz using an FPGA, recording the sampled sequence to memory, and recalling the recorded sequence after a programmable delay. To ensure reproducible test results, all CDE internal digital clocks were derived from CLK1. Careful manipulation of the CDE's output clock allowed the delay to be varied over time, in a manner such as described in Novellini, “Xilinx: The best platform when it comes to PTP accuracy,” Advanced Micro Devices, WP524 (2020), the entire contents of which are incorporated by reference herein. Delay was controlled using a piecewise polynomial spline to ensure there are no discontinuities in delay-vs-time. Validation of CDE performance has been described in Utter et al., “Dynamic binary channel delay emulation with picosecond-scale precision,” IEEE Aerospace Conference (2023). The CDE supports a maximum delay of one second, calibrated accuracy of ±20 ps, and range-rate up to 30 km/s.

Software running on a control server monitored both PTP endpoints and allowed the programming of dynamic CDE scenarios, including scenarios derived from satellite orbital dynamics or other physics-based models.

The system described with reference to FIG. 7 demonstrated rate-range accuracy of ±20 cm/s over an emulated free-space optical channel.

### 8. Conclusion

Conventional PTP offers excellent time-transfer performance over computer networks, but it can only operate on fixed infrastructure. As provided herein, PTP may operate on mobile networks with two changes to the operation of PTP transparent clocks. The first is a novel method for incremental updates to the existing correctionField that incorporate range-rate information. The second is a novel method for measuring range-rate information even if local reference clocks have not yet converged. An end-to-end prototype incorporating these changes has demonstrated range-rate accuracy of ±20 cm/s over an emulated free-space optical channel.

### 9. Example Implementation

The node functions described herein may be implemented using any suitable combination of hardware and software. For example, any suitable functionalities of the first and second endpoints and the relay nodes may be implemented using a suitably programmed field-programmable gate array (FPGA) or application-specific integrated circuit (ASIC). FPGAs and ASICs are commercially available, and methods of programming same to achieve desired logical programming are known in the art. In still other configurations, the functionalities of one or more of the first and second endpoints and the relay nodes may be implemented using a suitably programmed computer, e.g., a suitably programmed general purpose computer including a non-volatile computer-readable medium storing instructions for causing the endpoints or nodes to perform such functions.

### Additional Examples

While various illustrative embodiments of the invention are described above, it will be apparent to one skilled in the art that various changes and modifications can be made therein without departing from the invention. The appended claims are intended to cover all such changes and modifications that fall within the true spirit and scope of the invention.

What is claimed is:

1. A method for calculating a range-rate in a mobile network, the method comprising:
transmitting, by a first endpoint in a mobile network, a request message initializing a dopplerField (DF);
receiving, by one or more relay node(s), at least some of which may be moving relative to the first endpoint, the request message;
measuring, by each relay node, an ingress frequency ratio of the request message and an egress frequency ratio of the request message;
incrementing, by each relay node, DF by a difference between the ingress frequency ratio and the egress frequency ratio of the request message;
transmitting, by each relay node, the request message containing the incremented DF;
receiving, by a second endpoint, the request message containing the incremented DF;
generating, by the second endpoint, a reply message containing the incremented DF;
receiving, by each relay node, the reply message;
measuring, by each relay node, an ingress frequency ratio of the reply message and an egress frequency ratio of the reply message;
incrementing, by each relay node, the incremented DF by a difference between the ingress frequency ratio and the egress frequency ratio of the reply message;
transmitting, by each relay node, the reply message containing the incremented DF;
receiving, by the first endpoint, the reply message containing the incremented DF; and
using, by the first endpoint, the incremented DF to calculate a range-rate of components in the mobile network relative to the first endpoint.

2. The method of claim 1, wherein the request message transmitted by the first endpoint further contains a correctionField (CF).

3. The method of claim 2, further comprising incrementing, by each relay node, CF in the request message using operations comprising:
measuring, by each relay node, an ingress timestamp of the request message and an egress timestamp of the request message;
estimating, by each relay node, a first next-hop range rate; and
incrementing, by each relay node, CF using the first next-hop range rate and a difference between the ingress timestamp and the egress timestamp of the request message.

4. The method of claim 3, wherein the reply message comprises the incremented CF, the method further comprising incrementing, by each relay node, the incremented CF in the reply message using operations comprising:
measuring, by each relay node, an ingress timestamp of the reply message and an egress timestamp of the reply message;
estimating, by each relay node, a second next-hop range rate; and
incrementing, by each relay node, the incremented CF using the second next-hop range rate and a difference between the ingress timestamp and the egress timestamp of the reply message.

5. The method of claim 1, wherein the DF comprises a Type, Length, Value (TLV) field of a Precision Time Protocol (PTP).

6. A method for calculating a range-rate in a mobile network, the method comprising:
transmitting, by an endpoint in a mobile network to a node in the mobile network, a request message initializing a dopplerField (DF);
receiving, by the endpoint from the node, a reply message containing the DF which has been incremented by at least the node; and
using, by the endpoint, the incremented DF to calculate a range-rate of components in the mobile network relative to the endpoint.

7. The method of claim 6, wherein the request message transmitted by the first endpoint further contains a correctionField (CF).

8. The method of claim 6, wherein the DF comprises a Type, Length, Value (TLV) field of a Precision Time Protocol (PTP).

9. The method of claim 6, wherein the DF was incremented a first time by the node when receiving the request message from the endpoint, and incremented a second time by the node when transmitting the reply message to the endpoint.

10. A method for responding to a request message in a mobile network, the method comprising:
receiving, by an endpoint in a mobile network, a request message containing an incremented dopplerField (DF); and
transmitting, by the endpoint, a reply message containing an echo of the incremented DF.

11. A mobile network, comprising:
a first endpoint configured to transmit a request message initializing a dopplerField (DF);
one or more relay node(s), at least some of which may be moving relative to the first endpoint, configured to:
receive the request message;
measure an ingress frequency ratio of the request message and an egress frequency ratio of the request message;
increment DF by a difference between the ingress frequency ratio and the egress frequency ratio of the request message; and
transmit the request message containing the incremented DF;
a second endpoint configured to receive the request message containing the incremented DF and to generate a reply message containing the incremented DF;
the one or more relay nodes further configured to:
receive the reply message;
measure an ingress frequency ratio of the reply message and an egress frequency ratio of the reply message;
increment the incremented DF by a difference between the ingress frequency ratio and the egress frequency ratio of the reply message; and
transmit the reply message containing the incremented DF;
the first endpoint further configured to:
receive the reply message containing the incremented DF; and
use the incremented DF to calculate a range-rate of components in the mobile network relative to the first endpoint.

12. The mobile network of claim 11, wherein the request message transmitted by the first endpoint further contains a correctionField (CF).

13. The mobile network of claim 12, wherein each relay node is configured to increment CF in the request message using operations comprising:
measuring an ingress timestamp of the request message and an egress timestamp of the request message;
estimating a first next-hop range rate; and
incrementing CF using the first next-hop range rate and a difference between the ingress timestamp and the egress timestamp of the request message.

14. The mobile network of claim 13, wherein the reply message comprises the incremented CF, wherein each relay node is configured to increment the incremented CF in the reply message using operations comprising:
measuring an ingress timestamp of the reply message and an egress timestamp of the reply message;
estimating a second next-hop range rate; and
incrementing the incremented CF using the second next-hop range rate and a difference between the ingress timestamp and the egress timestamp of the reply message.

15. The mobile network of claim 11, wherein the DF comprises a Type, Length, Value (TLV) field of a Precision Time Protocol (PTP).

16. An endpoint for use in a mobile network, the endpoint configured to perform operations comprising:
transmitting, to a node in the mobile network, a request message initializing a dopplerField (DF);
receiving, from the node, a reply message containing the DF which has been incremented by at least the node; and
using the incremented DF to calculate a range-rate of components in the mobile network relative to the endpoint.

17. The endpoint of claim 16, wherein the request message transmitted by the first endpoint further contains a correctionField (CF).

18. The endpoint of claim 16, wherein the DF comprises a Type, Length, Value (TLV) field of a Precision Time Protocol (PTP).

19. The endpoint of claim 16, wherein the DF was incremented a first time by the node when receiving the request message from the endpoint, and incremented a second time by the node when transmitting the reply message to the endpoint.

20. An endpoint for use in a mobile network, the endpoint configured to perform operations comprising:
receiving a request message containing an incremented dopplerField (DF); and
transmitting a reply message containing an echo of the incremented DF.
